(19) United States
(12) Patent Application Publication
(10) Pub. No.: US 2020/0148940 A1
(43) Pub. Date: May 14, 2020

(54) METHOD FOR STEAM EXTRACTION OF BITUMEN

(71) Applicant: Dow Global Technologies LLC, Midland, MI (US)

(72) Inventors: Alexander Williamson, Rosharon, TX (US); Cole A. Witham, Pearland, TX (US); Timothy J. Young, Bay City, MI (US)

(21) Appl. No.: 16/612,833

(22) PCT Filed: Apr. 16, 2018
(86) PCT No.: PCT/US2018/027739

§ 371 Date: Nov. 12, 2019

Related U.S. Application Data
(60) Provisional application No. 62/505,349, filed on May 12, 2017.

(51) Int. Cl. C09K 8/592; C10G 1/04

(52) U.S. Cl. CPC C09K 8/592; C10G 1/04

(57) ABSTRACT

The present invention relates to an in situ bitumen recovery process from oil sands. Specifically, the present invention involves the step of treating oil sands with an alkanolamine having a hydrophilic-lipophilic balance factor (HLB-factor) of 0.5 to −2.2 as determined by summing up the Davies HLB contributions for each functional group on the substituents and applying the following equation: HLB-factor=HLB_{(longest chain)}+0.5×HLB_{(second longest chain)}+0.25_{(third longest chain)}.

### FIELD OF THE INVENTION

The present invention relates to the recovery of bitumen from oil sands. More particularly, the present invention is an improved method for bitumen recovery from oil sands through in situ recovery. The improvement is the use of an alkanolamine with a hydrophilic-lipophilic balance factor (HLB-factor) between 0.5 to −2.2 as an extraction aid in the steam used in the bitumen SAGD recovery process.

### BACKGROUND OF THE INVENTION

In some areas of the world there are large deposits of viscous or heavy crude oils and/or oil or tar sands which are located near the surface of the earth. The overburden in such areas may be nonextant but may also be as much as three hundred feet, or more. When the hydrocarbons are sufficiently shallow, the hydrocarbons may be effectively produced using strip mining or other bulk mining methods.

When hydrocarbons are too deep for bulk mining method, then the use of wells in combination with steam injection may be used to produce the hydrocarbons. One such method is known as steam flooding.

In steam flooding of an oil sands formation, for example, a pattern of wells is drilled vertically through the overburden and into the heavy oil sand, usually penetrating the entire depth of the sand. Casing is put in place and perforated in the producing interval and then steam generated at the surface is pumped under relatively high pressure down the casing and into the heavy oil formation.

In some instances the steam may be pumped for a while into all of the wells drilled into the producing formation and, after the heat has been used to lower the viscosity of the heavy oil near the well bore then the steam is removed and the heated, lowered viscosity, oil is pumped to surface, having entered the casing through the perforations. When the heat has dissipated and the heavy oil production falls off, the production is closed and the steam flood resumed. Where the same wells are used to inject steam for a while and then for production, this technique has been known as the huff and puff method or the push-pull method.

In other instances, some of the vertical wells penetrating the heavy oil sands are used to continuously inject steam while others are used to continuously produce lower viscosity oil heated by the steam. Again, when heavy oil production falls off due to lack of heat, the role of the injectors and producers can be reversed to allow injected steam to reach new portions of the reservoir and the process repeated.

In all of these production techniques, the steam flood is performed at a relatively high pressure (hundreds to over one thousand pounds per square inch or PSI) so as to allow it to penetrate as deeply into the production zone as possible.

One of the more advanced technologies for recovering heavy crude oil and bitumen is that of “Steam Assisted Gravity Drainage”, or SAGD. In this method, two parallel horizontal oil wells are drilled in the formation. Each well pair is drilled parallel and vertically aligned with one another. They are typically about 1 kilometer long and 5 meters apart. The upper well is known as the “injection well” and the lower well is known as the “production well”. The process begins by circulating steam in both wells so that the bitumen between the well pair is heated enough to flow to the lower production well. The freed pore space is continually filled with steam forming a “steam chamber”. The steam chamber heats and drains more and more bitumen until it has overtaken the oil-bearing pores between the well pair. Steam circulation in the production well is then stopped and injected into the upper injection well only. The cone shaped steam chamber, anchored at the production well, now begins to develop upwards from the injection well. As new bitumen surfaces are heated, the oil's viscosity is reduced, allowing it to flow downward along the steam chamber boundary into the production well by way of gravity. Steam is always injected below the fracture pressure of the rock mass. Also, the production well is often throttled to maintain the temperature of the bitumen production stream just below saturated steam conditions to prevent steam vapor from entering the well bore and diluting oil production—this is known as the SAGD “steam trap”.

The SAGD process typically recovers about 55% of the original bitumen-in-place. Other engineering parameters affecting the economics of SAGD production include the recovery rate, thermal efficiency, steam injection rate, steam pressure, minimizing sand production, reservoir pressure maintenance, and water intrusion.

SAGD offers a number of advantages in comparison with conventional surface mining extraction techniques and alternate thermal recovery methods. For example, SAGD offers significantly greater per well production rates, greater reservoir recoveries, reduced water treating costs and dramatic reductions in “Steam to Oil Ratio” (SOR).

Relying upon gravity drainage, SAGD requires comparatively thick and homogeneous reservoirs. Production rates are limited by the relatively high viscosity of bitumen, even hot. Derivative processes are being developed to increase production rates by adding volatile, bitumen-soluble solvents, such as condensable or non-condensable hydrocarbons, to the steam to lower the bitumen viscosity.

Conventional alkaline enhanced oil recovery agents, such as mineral hydroxides (e.g., NaOH, KOH) and carbonates (e.g. NaHCO₃, Na₂CO₃), can be carried to the oil bearing formation dissolved in any residual hot water in left in the produced steam, but are not volatile enough to be carried by steam alone. In the SAGD process in particular, there is a long and tortuous path through a sand-packed, dry, stream chamber to the water condensation/oil draining front, through which even the smallest water aerosol is unlikely to penetrate.

Certain volatile reagents, such as amines, silanes, organosilicons, and ureas can enhance the recovery of light hydrocarbons by reacting with the surfaces of mineral fines or with the mineral formation itself to decrease the mobility of fines or water or otherwise improve permeability of oil through the formation. With oil sands in particular, however, the surface area of the mineral fines is so many times greater than that of the bitumen particles that any mineral or formation treating method becomes uneconomical.

Thus, there remains a need for efficient, safe and cost-effective methods to improve the in situ recovery of bitumen from oil sands.

### SUMMARY OF THE INVENTION

The present invention is an improved bitumen recovery process comprising the step of treating oil sands with a composition comprising, consisting essentially of, or consisting of an alkanolamine having a hydrophilic-lipophilic balance factor (HLB-factor) between 0.5 to −2.2 and steam wherein the treatment is to oil sands recovered by in situ production to oil sands in a subterranean reservoir.

In one embodiment of the bitumen recovery process described herein above, the alkanolamine of the present invention is represented by the following formula:

R₁R₂N—R₃OH I

where R₁ and R₂ are independently H or a linear or branched alkyl group of 1 to 4 carbons or R₁ and R₂ comprise a cyclic group of 3 to 7 carbons and R₃ is a linear or branched alkyl group of 1 to 8 carbons wherein the —OH group can be a primary —OH, a secondary —OH, or a tertiary —OH group substituted on the 1 to 8 carbon alkyl group R₃.

In one embodiment the alkanolamine is N-ethylethanolamine, N,N-diethylethanolamine, 3-amino-1-propanol, N-methyl-3-amino-1-propanol, N, N-dimethyl-3-amino-1-propanol, N, N-diethyl-3-amino-1-propanol, 3-amino-2-propanol, N-methyl-3-amino-2-propanol, N, N-dimethyl-3-amino-2-propanol, N, N-diethyl-3-amino-2-propanol, 4-amino-1-butanol, N-methyl-4-amino-1-butanol, N, N-dimethyl-4-amino-1-butanol, N, N-diethyl-4-amino-1-butanol, 4-amino-2-butanol, N-methyl-4-amino-2-butanol, N, N-dimethyl-4-amino-2-butanol, N, N-diethyl-4-amino-2-butanol, 4-amino-3-butanol, N-methyl-4-amino-3-butanol, N, N-dimethyl-4-amino-3-butanol, N, N-diethyl-4-amino-3-butanol, 5-amino-1-pentanol, N-methyl-5-amino-1-pentanol, N, N-dimethyl-5-amino-1-pentanol, N, N-diethyl-5-amino-1-pentanol, 6-amino-1-hexanol, 7-amino-1-heptanol, or 8-amino-1-octanol.

Preferably, the alkanolamine is N-ethylethanolamine, 3-amino-1-propanol, N-methyl-3-amino-1-propanol, N, N-dimethyl-3-amino-1-propanol, 3-amino-2-propanol, N-methyl-3-amino-2-propanol, N, N-dimethyl-3-amino-2-propanol, 4-amino-1-butanol, N-methyl-4-amino-1-butanol, N, N-dimethyl-4-amino-1-butanol, 5-amino-1-pentanol, N-methyl-5-amino-1-pentanol, N, N-dimethyl-5-amino-1-pentanol, or 6-amino-1-hexanol.

In another embodiment of the present invention, the bitumen recovery process by in situ production described herein above comprises the steps of: i) treating a subterranean reservoir of oil sands by injecting steam containing the alkanolamine composition into a well, and ii) recovering the bitumen from the well, preferably the concentration of the alkanolamine in the steam is in an amount of from 100 ppm to 10 weight percent.

### DETAILED DESCRIPTION OF THE EMBODIMENTS

In one embodiment, the present invention is a method for producing a heavy hydrocarbon. For the purposes of this application, a heavy hydrocarbon includes dense or high viscosity crude oils and bitumen.

Heavy hydrocarbons can be difficult to produce. These hydrocarbons are very viscous and often cannot be produced using oil wells that are powered only by formation pressures. One method of lowering the viscosity of heavy hydrocarbons in subterranean formations is to flood the formation with steam. Steam increases the temperature of the hydrocarbons in the formation, which lowers their viscosity, allowing them to drain or be swept towards an oil well and be produced. Steam can also condense into water, which can then act as a low viscosity carrier phase for an emulsion of oil, thereby allowing heavy hydrocarbons to be more easily produced.

In one embodiment, the invention is a method of recovering heavy hydrocarbons using an oil well. In this embodiment, the hydrocarbon in a subterranean formation is contacted with an admixture of steam and a volatile alkanolamine. The steam, volatile alkanolamine admixture is introduced downhole using either the same well used for production or other wells used to introduce the steam into the formation. Either way, the steam condenses and forms an aqueous phase which can help liberate the heavy hydrocarbon from the mineral and carry it towards the production well.

In another embodiment, the invention is a method of recovering heavy hydrocarbons, especially bitumen, where the heavy hydrocarbon is recovered from a hydrocarbon bearing ore. One such ore is the bitumen rich ore commonly known as oil sand(s) or tar sand(s).

Enormous hydrocarbon reserves exist in the form of oil sands. The asphalt-like glassy bitumen found therein is often more difficult to produce than more liquid forms of underground hydrocarbons. Oil sands bitumen does not flow out of the ground in primary production. Such ore may be mined in open pits, the bitumen separated from the mineral ex situ using at least warm water, sometimes heated with steam, in giant vessels on the surface. Or the ore can be heated with steam in situ, and the bitumen separated from the formation matrix while still underground with the water condensed from the steam.

Unlike conventional heavy crude oils, the bitumen in oil sand is not continuous but in discrete bits intimately mixed with silt or capsules encasing individual grains of water wet sand. These bituminous hydrocarbons are considerably more viscous than even conventional heavy crude oils and there is typically even less of it in the formation-even rich oil sand ores bear only 10 to 15 percent hydrocarbon.

One method of recovering such bitumen is to clear the earthen overburden, scoop up the ore from the open pit mine, and then use heated water to wash away the sand and silt ex situ, in a series of arduous separation steps.

A more recent process separates the hydrocarbons from the sand in situ using horizontal well pairs drilled into the deeper oil sand formations. High pressure, 500° C., dry steam is injected into an upper (injector) well, which extends lengthwise through the upper part of the oil sand deposit. The steam condenses, releasing its latent and sensible heat which melts and fluidizes the bitumen near the injector well. As the oil and water, now at about 130° C. to about 230° C., drains, a dry steam chamber forms above the drainage zone.

One disadvantage to this method of hydrocarbon production is that new steam, along with any additives that it may include, may have to travel ever longer distances through this porous sand and clay to reach the progressing interface between the dry steam chamber and the zone where the oil and water drainage commences (a production front). This process is known as steam assisted gravity drainage and is commonly referred to by its acronym, “SAGD.”

Unlike a conventional steam drive, the pressure of the steam is not primarily used to push the oil to the producer well; rather, the latent heat of the steam is used to reduce the viscosity of the bitumen so that it drains, along with the water condensed from the steam, to the lower, producer well by gravity. Since, at the production temperature of about 150° C., pure water is about 300 times less viscous than pure bitumen, and the typically water-wet formation can't hydrophobically impede the flow of water, the water drains much faster through the formation than the melted bitumen.

Moreover, water-based (oil-in-water) emulsions flow mostly like water, they are not much more viscous than water itself. This is believed to be because the charge stabilized, oil-in-water particles are electrostatically repelled and resist rubbing against each other. Water droplets in oil, in contrast, are sterically stabilized and flow past each other only with increased friction. The result is that concentrated emulsions of water in oil can be several times more viscous than the pure oil itself. Thus, overall, a water-based emulsion can flow as much as a thousand times faster than its oil based counterpart, and so typically produce far more oil, even when it carries a lower fraction of oil.

In a typical SAGD start-up, water is the first thing out of the ground. The concentration of hydrocarbon in the production fluid increases with time until eventually the oil concentration levels out at about 25 to 35 percent of the produced fluid. Thus the limiting “steam to oil ratio” or SOR is about 2 to 3.

Whatever the condition of the fluids underground, what reaches the first phase separator on the surface may not be two bulk phases, that is, an oil-based emulsion and a water-based emulsion. Instead, the predominant emulsion is usually oil-in-water. This emulsion typically carries with it is the most bitumen it can carry without flipping states, or inverting, into a water-in-oil emulsion.

In practice then, the SOR, and thus the oil production rate, may be more limited by the fluid flux, the transfer of motion to the oil via the water flow, than the thermal flux, the transfer of heat to the oil via steam. Increasing the fraction of oil carried by the water, then, produces more oil for same steam, and is thus highly desirable.

Two advantages of the method of the invention are that the use of the alkanolamines can increase both the efficiency and the effectiveness with which heavy hydrocarbons are dispersed into (and thus carried by) water. Increased efficiency results in lower steam requirements, which results in lower energy costs. In some fields, heavy crude oil is recovered at a cost of ⅓ of the oil produced being used to generate steam. It would be desirable in the art to lower steam requirements thereby lowering the use of recovered hydrocarbons or purchased energy in the form of natural gas for producing heavy hydrocarbons. Increased effectiveness results in greater total recovery of bitumen from the formation. Less oil is left wasted in the ground. This increases the return for the fixed capital invested to produce it.

In one embodiment of the present invention, the improvement to the in situ process of recovering bitumen from oil sands from a subterranean reservoir is contacting the oil sands containing the bitumen with a composition comprising, consisting essentially of, or consisting of an alkanolamine having an HLB-factor between −2.2 to 0.5.

The HLB-factor, of the alkanolamine has a significant impact on the ability of the alkanolamine to emulsify bitumen. The HLB-factor of an alkanolamine molecule is determined for each functional group on the substituents by applying the following equation:

HLB-factor=HLB_{(longest chain)}+0.5×HLB_{(second longest chain)}+0.25×HLB_{(third longest chain)}

where HLB (chain) means the sum of the Davies' group contributions for that particular chain, not including the nitrogen atom. Davies' HLB group contributions are well known in the literature. The Davies' group contribution for —CH—, —CH₂—, and —CH₃ groups is −0.475, and the Davies' group contribution for the —OH group is 1.9.

Preferably, the alkanolamines used in the process of the present invention have an HLB-factor of 0.5 to −2.2.

Suitable alkanolamines useful in the of the bitumen recovery process of the present invention are represented by the following formula:

R₁R₂N—R₃OH I

where R₁ and R₂ are independently H or a linear or branched alkyl group of 1 to 4 carbons or R₁ and R₂ comprise a cyclic group of 3 to 7 carbons and R₃ is a linear or branched alkyl group of 1 to 8 carbons wherein the —OH group can be a primary —OH, a secondary —OH, or a tertiary —OH group substituted on the 1 to 8 carbon alkyl group R₃.

In one embodiment the alkanolamine is N-ethylethanolamine, N,N-diethylethanolamine, 3-amino-1-propanol, N-methyl-3-amino-1-propanol, N, N-dimethyl-3-amino-1-propanol, N, N-diethyl-3-amino-1-propanol, 3-amino-2-propanol, N-methyl-3-amino-2-propanol, N, N-dimethyl-3-amino-2-propanol, N, N-diethyl-3-amino-2-propanol, 4-amino-1-butanol, N-methyl-4-amino-1-butanol, N, N-dimethyl-4-amino-1-butanol, N, N-diethyl-4-amino-1-butanol, 4-amino-2-butanol, N-methyl-4-amino-2-butanol, N, N-dimethyl-4-amino-2-butanol, N, N-diethyl-4-amino-2-butanol, 4-amino-3-butanol, N-methyl-4-amino-3-butanol, N, N-dimethyl-4-amino-3-butanol, N, N-diethyl-4-amino-3-butanol, 5-amino-1-pentanol, N-methyl-5-amino-1-pentanol, N, N-dimethyl-5-amino-1-pentanol, N, N-diethyl-5-amino-1-pentanol, 6-amino-1-hexanol, 7-amino-1-heptanol, or 8-amino-1-octanol.

Preferably, the alkanolamine is N-ethylethanolamine, 3-amino-1-propanol, N-methyl-3-amino-1-propanol, N, N-dimethyl-3-amino-1-propanol, 3-amino-2-propanol, N-methyl-3-amino-2-propanol, N, N-dimethyl-3-amino-2-propanol, 4-amino-1-butanol, N-methyl-4-amino-1-butanol, N, N-dimethyl-4-amino-1-butanol, 5-amino-1-pentanol, N-methyl-5-amino-1-pentanol, N, N-dimethyl-5-amino-1-pentanol, or 6-amino-1-hexanol.

The alkanolamine is present in the steam in a concentration of equal to or greater than 100 ppm, preferably equal to or greater than 500 ppm, preferably equal to or greater than 1,000 ppm, or preferably equal to or greater than 2,000 ppm.

The alkanolamine is present in the steam in a concentration of equal to or less than 10 percent, preferably equal to or less than 2 percent, preferably equal to or less than 1 percent, or preferably equal to or less than 5,000 ppm.

The method of the invention may be desirably practiced in the absence of other reagents, reactants, or surfactants that may be introduced from the surface. In other words, only the alkanolamine of the present invention and steam are introduced to the subterranean formation.

The basic steps in the in situ treatment to recover bitumen from oil sands includes: steam injection into a well, recovery of bitumen from the well, and dilution of the recovered bitumen, for example with condensate, for shipping by pipelines.

In accordance with this method, the alkanolamine composition is used as a steam additive in a bitumen recovery process from a subterranean oil sands reservoir. The mode of steam injection may include one or more of steam drive, steam soak, or cyclic steam injection in a single or multi-well program. Water flooding may be used in addition to one or more of the steam injection methods listed herein above.

Typically, the steam is injected into an oil sands reservoir through an injection well, and wherein formation fluids, comprising reservoir and injection fluids, are produced either through an adjacent production well or by back flowing into the injection well.

In most oil sands reservoirs, a steam temperature of at least 180° C., which corresponds to a pressure of 150 psi (1.0 MPa), or greater is needed to mobilize the bitumen. Preferably, the alkanolamine composition-steam injection stream is introduced to the reservoir at a temperature in the range of from 150° C. to 300° C., preferably 180° C. to 260° C. The particular steam temperature and pressure used in the process of the present invention will depend on such specific reservoir characteristics as depth, overburden pressure, pay zone thickness, and bitumen viscosity, and thus will be worked out for each reservoir.

It is preferable to inject the alkanolamine composition simultaneously with the steam in order to ensure or maximize the amount moving with the steam. In some instances, it may be desirable to precede or follow a steam-alkanolamine composition injection stream with a steam-only injection stream. In this case, the steam temperature can be raised above 260° C. during the steam-only injection. The term “steam” used herein is meant to include superheated steam, saturated steam, and less than 100 percent quality steam.

For purposes of clarity, the term “less than 100 percent quality steam” refers to steam having a liquid water phase present. Steam quality is defined as the weight percent of dry steam contained in a unit weight of a steam-liquid mixture. “Saturated steam” is used synonymously with “100 percent quality steam”. “Superheated steam” is steam which has been heated above the vapor-liquid equilibrium point. If super-heated steam is used, the steam is preferably super-heated to between 5° C. to 50° C. above the vapor-liquid equilibrium temperature, prior to adding the alkanolamine composition.

The alkanolamine composition may be added to the steam neat or as a concentrate. If added as a concentrate, it may be added as a 1 to 99 weight percent solution in water. Preferably, the alkanolamine composition is substantially volatilized and carried into the reservoir as an aerosol or mist. Here again, the rationale is to maximize the amount of alkanolamine traveling with the steam into the reservoir.

Preferably the alkanolamine has a boiling point equal to or less than 300° C. at atmospheric pressure.

The alkanolamine composition is preferably injected intermittently or continuously with the steam, so that the steam-alkanolamine composition injection stream reaches the downhole formation through common tubing. The rate of alkanolamine composition addition is adjusted so as to maintain the preferred alkanolamine concentration of 1,000 ppm to 1 weight percent in steam. The rate of steam injection for a typical oil sands reservoir might be on the order of enough steam to provide an advance through the formation of from 1 to 3 feet/day.

An effective SAGD additive must satisfy many requirements to be considered as successful. The major criteria of a successful additive is the ability of the additive to travel with steam and reach unrecovered in-situ bitumen in reservoir formation, favorably interact with water/bitumen/rock to enhance bitumen recovery, and not adversely interfere with existing operations. Among the three, the requirement of an additive to vaporize at SAGD operating temperatures and travel with steam limits the choice and consideration of different chemistries in SAGD technology. For example, many high molecular weight surfactants even though are known to help enhance oil recovery are not considered as SAGD additives due to their inability to travel with steam owing to high boiling point.

In some applications, it is desirable that the alkanolamines have a volatility that is sufficient to allow for their delivery to the production front though a depleted formation with dry steam. For example, the surfactants formed in situ by such a delivery may accelerate the release (or inhibit the adsorption) of bitumen encapsulating sand grains in oil sands. This release may generate stable, low viscosity, bitumen-in-water dispersions or emulsions that flow more swiftly through a water-wet sandpack. Thus, this more oil laden water accelerates the recovery of bitumen from oil sands.

In such an embodiment, the condensed water is also able to carry a higher loading of this surface-activated bitumen than non-activated bitumen. Higher carrying capacity reduces the water and thus the steam and thus the natural gas (or other energy source) needed to produce a barrel of bitumen. In such a business model, capital costs may be more quickly recovered, and operating costs are permanently reduced, all of which are clearly desirable in a commercial operation.

The alkanolamine compounds added to steam may be sufficiently volatile to be transported by the steam in the vapor phase such that it can penetrate the formation to the bitumen draining front or production front where the steam is condensing.

There may in some cases be an optimum volatility which concentrates the alkanolamine by condensing it in a particular production zone.

### EXAMPLES

Examples 1 to 15 are prepared by mixing an alkanolamine with distilled water in order to obtain stock solutions having a concentration of 2,000 ppm

Solutions which appear turbid are heated to 60° C. and held at that temperature until the alkanolamine completely dissolves. Separately, bitumen is diluted to 85% w/w with a mixture of 50:50 dodecane:toluene to form a diluted bitumen, or dilbit, solution. A sample of the dilbit solution is pipetted into 1 mL glass vials. An equal volume of the alkanolamine solution is pipetted on top of the bitumen and the vials are sealed with polyethylene caps. The vials are then heated to 70° C.

Once at temperature, images are taken of each vial before and two hours after shaking. Shaking is accomplished via either manual hand shaking or via a robotic wrist shaker for 30 seconds at maximum shake speed. The sample vials can be heated, shaken, and imaged by any means known to those skilled in the art, whether manually on an individual vial basis, or in an automated, high-throughput research arrangement.

The HLB-factor for each sample is determined according to the following equation:

HLB-factor=HLB_{(longest chain)}+0.5×HLB_{(second longest chain)}+0.25×HLB_{(third longest chain)}

The emulsion rating is evaluated visually and assigned a value of 0 to 4 where:
0=no observable emulsion formation after 2 hours,
1=slight coloration of aqueous phase after 2 hours,
2=slight/moderate coloration of aqueous phase after 2 hours,
3=moderate coloration of aqueous phase after 2 hours, and
4=strong coloration of aqueous phase after 2 hours.

The emulsion rating is a qualitative rating based on the extent of emulsification of bitumen in the aqueous phase. The darker the aqueous phase, the better the emulsion is considered to be. In cases where the bitumen sticks to the side of the glass vessel but no good emulsion is formed, the sample is given a rating of 0. A rating of 2, 3, or 4 is considered acceptable emulsifying performance.

TABLE 1

| | | | 2^{nd} | 3^{rd} | | |
|---|---|---|---|---|---|---|
| | | Longest | Longest | Longest | HLB- | Emulsion |
| Ex | | Chain | Chain | Chain | factor | Rating |
| 1* | N-methylethanolamine | 0.95 | −0.475 | 0 | 0.7125 | 1 |
| 2* | Dimethylethanolamine | 0.95 | −0.475 | −0.475 | 0.59375 | 1 |
| 3* | Diethanolamine | 0.95 | 0.95 | 0 | 1.425 | 0 |
| 4* | N-methyldiethanolamine | 0.95 | 0.95 | −0.475 | 1.30625 | 1 |
| 5* | Trisisopropanolamine | 0.475 | 0.475 | 0.475 | 0.83125 | 0 |
| 6* | 3-Diethylamino-1,2- | 2.375 | −0.95 | −0.95 | 1.6625 | 1 |
| | propanediol | | | | | |
| 7* | 3-Amino-1,2-propanediol | 2.375 | 0 | 0 | 2.375 | 1 |
| 8* | 2-Amino1,3-propanediol | 2.375 | 0 | 0 | 2.375 | 0 |
| 9* | Diisopropanolamine | 0.475 | 0.475 | 0 | 0.7125 | 1 |
| 10 | 3-Amino-1-propanol | 0.475 | 0 | 0 | 0.475 | 4 |
| 11 | 4-Amino-1-butanol | 0 | 0 | 0 | 0 | 4 |
| 12 | 5-Amino-1-pentanol | −0.475 | 0 | 0 | −0.475 | 4 |
| 13 | 6-Amino-1-hexanol | −0.95 | 0 | 0 | −0.95 | 4 |
| 14 | Diethylethanolamine | 0.95 | −0.95 | −0.95 | 0.2375 | 2 |
| 15 | Monoisopropanolamine | 0.475 | 0 | 0 | 0.475 | 2 |

*not examples of the invention

As can be seen from the data, the alkanolamines of the present invention having an HLB-factor between 0.5 and −2.2 are able to form improved oil-in-water emulsions with the diluted bitumen.

What is claimed is:

1. An method to recover bitumen comprising the step of in situ contacting oil sands in a subterranean reservoir with a composition comprising an alkanolamine having an HLB-factor, of 0.5 to −2.2 as determined by summing up the Davies' HLB contributions for each functional group on the substituents and applying the following equation:
HLB-factor=HLB_{(longest chain)}+0.5×HLB_{(second longest chain)}+0.25×HLB_{(third longest chain)}.

2. The method of claim 1 wherein the alkanolamine is described by the following structure:
R₁R₂N—R₃OH
where R₁ and R₂ are independently H or a linear or branched alkyl group of 1 to 4 carbons or R₁ and R₂ comprise a cyclic group of 3 to 7 carbons and R₃ is a linear or branched alkyl group of 1 to 8 carbons wherein the —OH group can be a primary —OH, a secondary —OH, or a tertiary —OH group substituted on the 1 to 8 carbon alkyl group R₃.

3. The method of claim 1 where in the alkanolamine is N-ethylethanolamine, N,N-diethylethanolamine, 3-amino-1-propanol, N-methyl-3-amino-1-propanol, N, N-dimethyl-3-amino-1-propanol, N, N-diethyl-3-amino-1-propanol, 3-amino-2-propanol, N-methyl-3-amino-2-propanol, N, N-dimethyl-3-amino-2-propanol, N, N-diethyl-3-amino-2-propanol, 4-amino-1-butanol, N-methyl-4-amino-1-butanol, N, N-dimethyl-4-amino-1-butanol, N, N-diethyl-4-amino-1-butanol, 4-amino-2-butanol, N-methyl-4-amino-2-butanol, N, N-dimethyl-4-amino-2-butanol, N, N-diethyl-4-amino-2-butanol, 4-amino-3-butanol, N-methyl-4-amino-3-butanol, N, N-dimethyl-4-amino-3-butanol, N, N-diethyl-4-amino-3-butanol, 5-amino-1-pentanol, N-methyl-5-amino-1-pentanol, N, N-dimethyl-5-amino-1-pentanol, N, N-diethyl-5-amino-1-pentanol, 6-amino-1-hexanol, 7-amino-1-heptanol, or 8-amino-1-octanol.

4. The method of claim 1 comprising the steps of:
i) treating a subterranean reservoir of oil sands by injecting steam containing the alkanolamine composition into a well,
and
ii) recovering the bitumen from the well.

5. The method of claim 4 wherein the concentration of the alkanolamine in the steam is in an amount of from 100 ppm to 10 weight percent.

6. The method of claim 4 wherein the concentration of the alkanolamine in the steam is in an amount of from 500 ppm to 5,000 ppm.

7. The method of claim 1 where the alkanolamine has a boiling point equal to or less than 300° C.
